(19) United States
(12) Patent Application Publication
(10) Pub. No.: US 2009/0128058 A1
(43) Pub. Date: May 21, 2009

(54) Overload Protection Circuit

(76) Inventors: Zahir Mohammad Ahmed, Torrance, CA (US); Chen Hongcheng, Yantai (CN)

Correspondence Address: LAW OFFICES OF NATAN EPSTEIN, 11377 WEST OLYMPIC BOULEVARD, TRIDENT CENTER - 9TH FLOOR, LOS ANGELES, CA, 90064, US

(21) Appl. No.: 12/269,861

(22) Filed: Nov. 12, 2008

Related U.S. Application Data
(60) Provisional application No. 60/987,527, filed on Nov. 13, 2007.

(51) Int. Cl. H02H 9/04; H05B 41/36

(52) U.S. Cl. 315/307; 361/91.5

(57) ABSTRACT

A current shut-off overload protection circuit useful for fluorescent lamp ballast protection and the like has at least one power transistor for supplying a load current to a circuit load, a protection circuit comprising a current sensing resistance connected for developing a voltage drop related to the circuit load, and a switching diode having a control input operative for turning off the power transistor by removing a bias level, as by grounding the transistor base, responsive to a preset level of the voltage drop such that the load current to the load is switched off upon the load current exceeding a maximum acceptable load current represented by a preset level of the voltage drop.

This application claims priority to the filing date of Provisional Patent Application No. 60/987,527 filed Nov. 13, 2007.

### BACKGROUND OF THE INVENTION

1. Field of the Invention

This invention relates generally to overload protection of electrical and electronic circuits and more particularly relates to a current overload sensing circuit configured for turning off power upon sensing an excessive current through a protected device or protected circuit.

2. State of the Prior Art

While various means exist for protecting circuits against excessive currents, a continuing need exists for simple, reliable and economical circuits for shutting down an overload current through a protected device or protected circuit with sufficient speed to avoid destruction of sensitive semiconductor devices and the like.

### SUMMARY OF THE INVENTION

A shut off circuit is disclosed including at least one power transistor for supplying a load current to a circuit load, a protection circuit comprising a current sensing resistance connected for developing a voltage drop related to the circuit load, a switching diode having a control input operative for substantially turning off the least one power transistor responsive to a preset level of the voltage drop such that the load current to the load is switched off upon the load current exceeding a maximum acceptable load current represented by a preset level of the voltage drop. For example, the load may be a fluorescent lamp load.

The preset level of the voltage drop may be set by at least one capacitance connected to the current sensing resistance. The shut off circuit may also have a resistance-capacitance network configured and connected for setting the preset level of the voltage drop thereby to set the maximum acceptable load current. The switching diode may be connected for turning off the least one power transistor by removing a bias level of the power transistor thereby to turn off the load current. In a preferred embodiment of the invention, the switching diode is connected for turning off the transistor by grounding a base input of the transistor. The switching diode is preferably a silicon controlled rectifier.

In a presently preferred embodiment an overload protected circuit has at least one power transistor for supplying a load current to a circuit load, a current sensing resistance connected for developing a voltage drop related to the circuit load, a silicon controlled rectifier connected for grounding a base of the power transistor thereby to switch off the load current responsive to a preset level of the voltage drop thereby to limit the load current to a maximum acceptable load current represented by the preset level of the voltage drop, and a resistance-capacitance network connected between the current sensing resistance and a gate input of the silicon controlled rectifier for setting the preset level thereby to set the maximum acceptable load current.

### BRIEF DESCRIPTION OF THE DRAWINGS

FIG. 1 shows the shut off protection circuit according to this invention; and

FIG. 2 is an exemplary application of the shut off circuit of FIG. 1 in a fluorescent lamp ballast.

### DETAILED DESCRIPTION OF THE PREFERRED EMBODIMENT

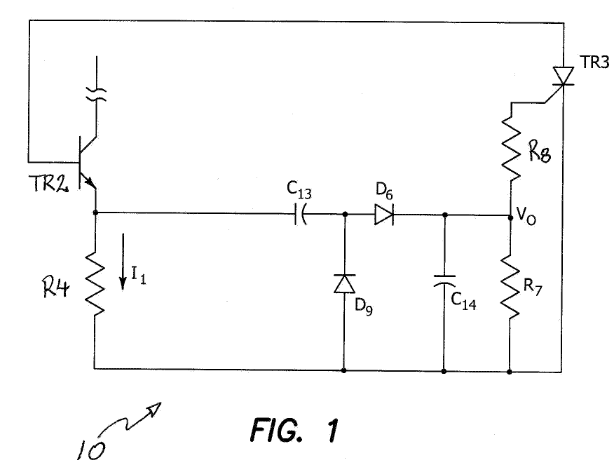

With reference to the accompanying drawings, wherein like elements are designated by like numerals, FIG. 1 illustrates an overload protection or shut-off circuit generally designated by numeral 10 in which a transistor TR2 is connected for carrying a load current designated by arrow 11 through a current sensing resistor R4. The load current through R4, such as a sine wave alternating current, develops a voltage drop across R4. A DC blocking capacitor C13 is connected between transistor TR2 and the top of R4, and feeds a sensed AC voltage drop to a rectifier network comprised of diodes D4 and D9. C13 also helps avoid nuisance tripping of the SCR due to DC components which may develop in the circuit. The rectified voltage charges a filter capacitor C14 connected between the output of the rectifying network D4-D9 and circuit ground. The output of filter capacitor C14 is damped by damping resistor R7 to arrive at a shut off trigger voltage V₀. Trigger voltage V₀ is fed through a current limiting resistor R8 to the gate input of switching diode or silicon controlled rectifier TR3. SCR TR3 is connected for grounding the base of transistor TR2 in response to triggering of the SCR'S gate by a sufficient trigger voltage V₀. In a typical silicon controlled rectifier, the minimum gate voltage required for triggering the SCR is approximately 0.7 volts, and consequently sensing resistor R4 is selected such that the necessary minimum trigger voltage V₀ develops at a maximum acceptable load current I₁ through transistor TR2.

Filter capacitor C14 serves to filter out voltage spikes and circuit noise to avoid nuisance tripping of the shut-off circuit 10. Capacitor C14 also sets a time delay for triggering SCR TR3 once the rectified current from the D4-D9 network exceeds the necessary minimum trigger voltage. This delay is caused by the charging time of C14, which is shorter for smaller capacitance values of C14 and larger for a greater capacitance. Accordingly, the value of C14 is selected to yield a desired trigger delay time for SCR TR3. For example, power transistor TR2 may have a specified transient current tolerance of a particular collector current for a particular maximum time interval. Capacitor C14 is selected so that upon sensing a load current across R4 near the maximum collector current rating of TR2 the SCR TR3 is triggered with a time delay smaller than the maximum rated pulse current tolerance time of transistor TR2. A typical time for a power transistor might be, for example, 300 milliseconds of a given overload or fault current through the transistor.

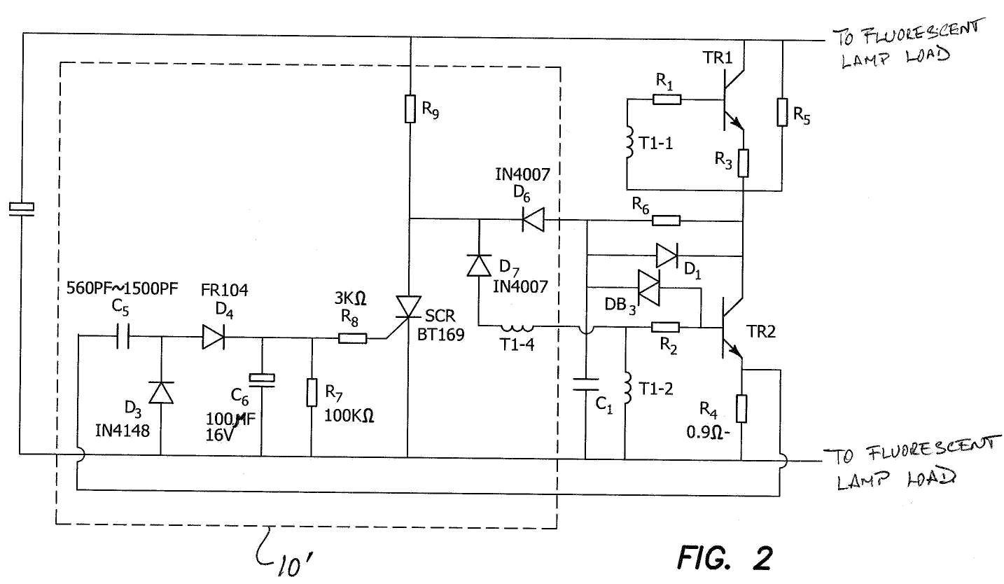

FIG. 2 shows, by way of example, a fluorescent lamp ballast circuit incorporating an overload protection circuit 10′ according to the circuit 10 of FIG. 1 and described above. Typical component values and semiconductor types for the overload protection circuit are shown in FIG. 2.

While a particular embodiment of the invention has been shown and illustrated for purposes of example and clarity, it should be understood that many changes, substitutions and modifications to the described embodiment will be apparent to those having only ordinary skill in the art without thereby departing from the scope and spirit of the invention, which is limited only by the following claims.

What is claimed is:

1. In a power supply circuit including at least one power transistor for supplying a load current to a circuit load, a protection circuit comprising a current sensing resistance connected for developing a voltage drop related to said circuit load, a switching diode having a control input operative for substantially turning off said least one power transistor responsive to a preset level of said voltage drop such that load current is switched off to said load upon said load current exceeding a maximum acceptable load current represented by said preset voltage drop.

2. The power supply circuit of claim 1 wherein said load is a fluorescent lamp load.

3. The power supply circuit of claim 1 further comprising at least one capacitance connected to said current sensing resistance for setting said preset level of said voltage drop.

4. The power supply circuit of claim 1 wherein said switching diode is connected for turning off said least one power transistor by removing a bias level of said power transistor.

5. The power supply circuit of claim 1 wherein said switching diode is a silicon controlled rectifier.

6. The power supply circuit of claim 4 wherein said switching diode is connected for turning off said transistor by grounding a base input of said transistor.

7. The power supply circuit of claim 1 further comprising a resistance-capacitance network configured and connected for setting said preset level of said voltage drop thereby to set said maximum acceptable load current.

8. A protection circuit for a power supply circuit of the type having at least one power transistor for supplying a load current to a circuit load, a protection circuit comprising a current sensing resistance connected for developing a voltage drop related to said circuit load, a silicon controlled rectifier connected for grounding a base of said power transistor thereby to switch off said load current responsive to a preset level of said voltage drop thereby to limit said load current to a maximum acceptable load current represented by said preset voltage drop, and a resistance-capacitance network configured and connected between said current sensing resistance and a control input of said silicon controlled rectifier for setting said preset level thereby to set said maximum acceptable load current.
